(19) United States
(12) Patent Application Publication
(10) Pub. No.: US 2006/0060435 A1
(43) Pub. Date: Mar. 23, 2006

(54) Return device having spring tension stabilization, and application to drum brakes

(75) Inventor: Vincent Dupuis, Saint Maur (FR)

Correspondence Address: LEO H MCCORMICK, 2112 MISHAWAKA AVE, P O BOX 4721, SOUTH BEND, IN, 46634, US

(73) Assignee: Robert Bosch GmbH

(21) Appl. No.: 11/216,550

(22) Filed: Aug. 31, 2005

(30) Foreign Application Priority Data
Sep. 22, 2004 (FR) 04/10036

(51) Int. Cl. B60T 8/18

(52) U.S. Cl. 188/195; 188/196 R

(57) ABSTRACT

A return device comprising at least one spring (2) exerting an elastic return force on two elements (11) which can be displaced between a rest position and a mutually parted end position separated from one another by a distance which increases with the wear on a part. and a load-relieving connecting piece (3) mounted in series with the spring (2) between the two moving elements (11). The load-relieving connecting piece (3) has a useful length (L) that increases with the wear as an elastic return force is exerted by the spring exceeding a predetermined load threshold.

### BACKGROUND OF THE INVENTION

The invention generally relates to mechanical return devices whose operation is subject to a wear process.

More specifically, the invention relates to a return device between two elements which can move relative to one another and are selectively displaced, with a mutual parting movement, from a rest position towards a parted end position, the rest and parted end positions being separated from one another by a distance which increases with the wear on at least one wear part and this device comprising at least one return spring connecting the two moving elements and exerting on these elements, in their parted end position, an elastic return force urging them to come together towards their rest position.

Such a device is for example conventionally employed, in a form reduced to the return spring alone, in drum brakes, to which the invention preferentially applies.

Specifically, the known drum brakes, of the type illustrated in FIG. 1, traditionally comprise two shoes 11 and 12 which, during braking, are displaced from their rest position towards a mutually parted end position in which they frictionally engage with a rotating drum (not shown).

This mutual parting movement of the shoes 11 and 12 is carried out against the elastic return force F (FIG. 5) primarily exerted by the return spring 2 which interconnects the two shoes 11 and 12.

However, as these shoes and the drum increasingly wear, with the wear being expressed in millimeters for example, the mutually parted end position of the shoes becomes increasingly distant from the rest position thereof.

As a result, at the end of the life of the shoes 11 and 12 and of the drum, that is to say when the wear has reached a maximum value Umax (FIG. 5), the return force exerted by the spring 2 on these shoes reaches a high, and therefore undesirable, value Fmax since this return force is deducted from the force exerted to actuate the brake.

### SUMMARY OF THE INVENTION

In this context, the aim of the invention is to provide a return device free from this failing.

To this end, the return device of the invention, otherwise in accordance with the generic definition given therefor by the preamble above, is essentially characterized in that it additionally comprises a load-relieving connecting piece mounted in series with the return spring between the two moving elements and having a useful length which increases with the wear on each wear part, this connecting piece experiencing an increase in its useful length in response to the elastic return force exceeding a predetermined load threshold.

In the preferred embodiment of the invention, it is for example provided that the connecting piece comprises an elongate guide, elongated in a first direction, joining the moving elements, that the return spring has a first end clamped in the elongate guide, and that this guide is provided with a succession of elastic obstacles projecting transversely to the first direction, at least locally inclined with respect to this first direction, and acting in the manner of running catches, the first end of the return spring progressing in the guide by successive jumps of the elastic obstacles as the wear on each wear part increases.

The connecting piece may be formed by a spring wire folded in the manner of a hairpin so as to present two opposite branches, the elastic obstacles then being, for example, formed by undulations of at least one of these two branches.

The connecting piece advantageously has a hook-shaped first end attached to one of the moving elements, it also being possible for the first end of the return spring to be hook-shaped.

If the two branches of the connecting piece bear undulations, the elastic obstacles may be formed by the undulations of these two branches converging and diverging in a coordinated manner.

In the case where the first end of the connecting piece formed by the spring wire is hook-shaped, this piece is preferably folded over on itself at its second end, opposite the first end, so as to form the two branches mentioned above.

The undulations of the two branches may then have minimum distances between them which increase from the first end of the connecting piece towards the second end of this connecting piece.

The return device of the invention is particularly applicable to a drum brake equipped with two shoes, each shoe in this case constituting both a moving element and a wear part.

Other features and advantages of the invention will become clearly apparent from the description of it below, which is given by way of illustration with no limitation being implied, with reference to the appended drawings.

### BRIEF DESCRIPTION OF THE DRAWINGS

FIG. 1 is a front view of a known drum brake;

FIG. 2 is an enlarged partial plan view of a device according to the invention, applied to a drum brake, a shoe of which is seen in section;

FIG. 3 is a perspective front view of a first embodiment of a connecting piece which can be used in a device according to the invention;

FIG. 4 is a perspective front view of a second embodiment of a connecting piece which can be used in a device according to the invention; and

FIG. 5 is a diagram representing the maximum return force exerted by a return spring in an assembly of the prior art and in a device according to the invention.

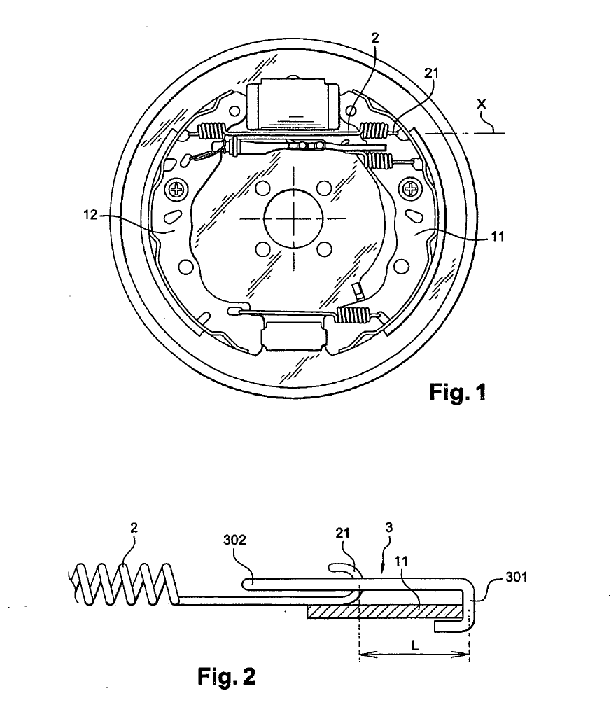

### DETAILED DESCRIPTION OF THE INVENTION

As stated above, the invention relates to a return device between two elements 11 and 12 which can move relative to one another and are selectively displaced from a rest position to a mutually parted end position.

In the application of the return device of the invention to drum brakes, which represents the preferred application of the invention and which will serve to support the detailed description below, the moving elements 11 and 12 consist of the shoes of this brake.

This return device comprises a return spring 2 which connects these shoes 11 and 12 and which exerts on them, in their parted end position, an elastic return force F urging them to come together towards their rest position.

As each of these shoes 11 and 12 constitutes not only a moving element but also a part directly subject to wear U by frictional engagement with the drum, the rest and parted end positions of these shoes are separated from one another by a distance which increases with their wear U.

In addition to the return spring 2, the device of the invention comprises a load-relieving connecting piece 3, which is mounted in series with the return spring 2 between the two shoes 11 and 12.

This piece 3 has a useful length L which increases with the wear U on the shoes 11 and 12.

More specifically, the useful length L of this connecting piece 3 experiences an increase each time the elastic return force F exerted by the spring 2 exceeds a predetermined load threshold F1.

In its preferred embodiment, this connecting piece 3 is formed by a spring wire folded in the manner of a hairpin so as to present two opposite branches 31 and 32, between which is defined an elongate guide 30, extending in the direction X, joining the shoes 11 and 12.

One end 21 of the return spring 2, for example a hook-shaped end, is trapped in the elongate guide 30, which is provided with a succession of obstacles 35 projecting transversely with respect to the direction X.

The obstacles 35 are for example formed by undulations of the branches 31 and 32, which converge and diverge in a coordinated manner, or are simply formed by undulations of only one of these branches, the other of which may be rectilinear.

In both cases, the obstacles 35 are inclined at least locally with respect to the direction X and thus act elastically in the manner of running catches by virtue of the elasticity of the clamp formed jointly by the branches 31 and 32.

When the shoes 11 and 12 are in their rest position, the return spring 2, which is preloaded, exerts on them a minimum return force F0 (FIG. 5).

When the brake is actuated and the shoes 11 and 12 are parted from one another so as to be brought closer to the drum, the return force F of the spring 2 increases along a slope essentially defined by the stiffness of this spring.

As the wear U increases, the return force F exerted by the spring 2 on the shoes 11 and 12 in their parted end position also increases.

When the wear U reaches an incremental value Uincr, this return force exceeds a predetermined load threshold F1.

Under these conditions, the end 21 of the return spring 2 applies a force to the inclined obstacles 35 which block it in the guide 30 such that the elastic clamp formed by the branches 31 and 32 opens.

The end 21 of the spring 2 then escapes from the obstacles 35 which were retaining it and comes into contact with the obstacles 35 following in the direction of elongation of the useful length L of the piece 3, this elongation immediately causing a reduction in the loading on the spring 2.

A person skilled in the art will understand that the end 21 of the spring 2 thus progresses in the guide 30 by successive jumps of the elastic obstacles 35 as the wear U on the shoes 11 and 12 increases.

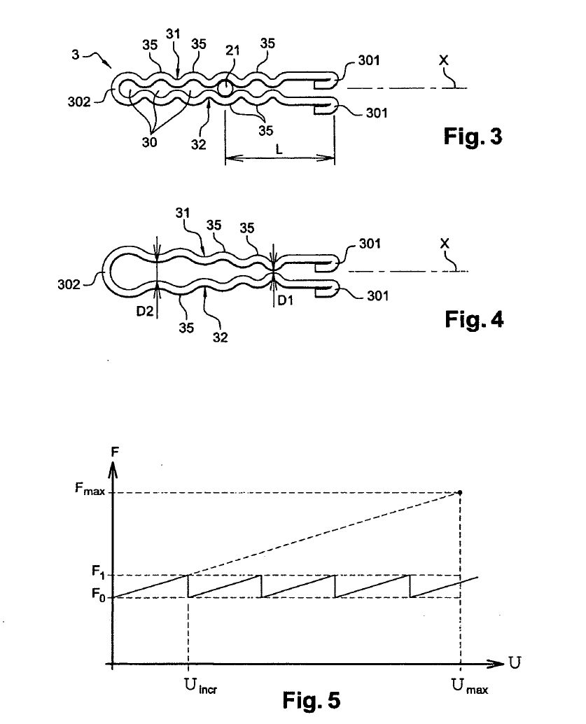

In the embodiments illustrated in FIGS. 3 and 4, the connecting piece 3 is, at its end 301, hook-shaped so that it can be attached to one of the shoes, for example to the shoe 11, while the spring wire which constitutes said connecting piece is folded over on itself at the other end 302 of this same connecting piece 3.

Instead of designing the guide 30 to have a constant width, as is the case for the embodiment shown in FIG. 3, it is possible to arrange for this guide to have a changing width, as illustrated in FIG. 4, in order to make the predetermined load threshold F1 as constant as possible.

In this case, the undulations of the two branches 31 and 32 have minimum distances, such as D1 and D2, between them which increase from the hook-shaped end 301 of the connecting piece 3 towards the end 302 of this same piece which is folded in the manner of a hairpin.

What is claimed is:

1. A return device between two elements (11, 12) that move relative to one another and are selectively displaced, with a mutual parting movement, from a rest position towards a parted end position, the rest and parted end positions being separated from one another by a distance that increases with the wear (U) on at least one wear part and this device comprising at least one return spring (2) connecting the two moving elements (11, 12) and exerting on these elements, in their parted end position, an elastic return force (F) urging them to come together towards their rest position, characterized in that the device additionally comprises a load-relieving connecting piece (3) mounted in series with the return spring (2) between the two moving elements (11, 12) and having a useful length (L) which increases with the wear (U) on each wear part, this connecting piece (3) experiencing an increase in its useful length (L) in response to the elastic return force (F) exceeding a predetermined load threshold (F1).

2. The return device according to claim 1, characterized in that the connecting piece (3) comprises an elongate guide (30), elongated in a first direction (X), joining the moving elements (11, 12), in that the return spring (2) has a first end (21) clamped in the elongate guide (30), and in that this guide (30) is provided with a succession of elastic obstacles (35) projecting transversely to the first direction (X), at least locally inclined with respect to this first direction, and acting in the manner of running catches, the first end (21) of the return spring (2) progressing in the guide (30) by successive jumps of the elastic obstacles (35) as the wear (U) on each wear part increases.

3. The return device according to claim 2, characterized in that the connecting piece (3) is formed by a spring wire folded in the manner of a hairpin so as to present two opposite branches (31, 32), and in that the elastic obstacles (31, 32) are formed by undulations of at least one of these two branches (31, 32).

4. The return device according to claim 3, characterized in that the connecting piece (3) has a hook-shaped first end (301) attached to one of the moving elements (11).

5. The return device according to claim 4, characterized in that the first end (21) of the return spring (2) is hook-shaped.

6. The return device according to claim 3, characterized in that the two branches (31, 32) of the connecting piece (3) bear undulations, and in that the elastic obstacles (35) are formed by the undulations of these two branches (31, 32) converging and diverging in a coordinated manner.

7. The return device according to claim 4, characterized in that the spring wire is folded over on itself at a second end (302) of the connecting piece (3), opposite the first end (301) of this connecting piece (3).

8. The return device according to claim 7, characterized in that the undulations of the two branches (31, 32) have minimum distances (D1, D2) between them which increase from the first end (301) of the connecting piece (3) towards the second end (302) of this connecting piece.

9. The return device according to claim 8 for use in a drum brake equipped with two shoes, characterized in that each shoe (11, 12) constitutes both a moving element and a wear part.
